(19) United States
(12) Patent Application Publication
(10) Pub. No.: US 2009/0289087 A1
(43) Pub. Date: Nov. 26, 2009

(54) CONTAINER WITH A DISPENSING CLOSURE COMPRISING A SAFETY SYSTEM

(75) Inventors: Pierre Henri Lebrand, Bonliers (FR); Bruno Sadi Henri Delande, Marseille en Beauvaisis (FR); Jean-Francois Andre Alme Launay, La Chapelle aux Pots (FR); Christophe Jean-Marie Yves Charlier, Allonne (FR)

Correspondence Address: K&L Gates LLP, P.O. Box 1135, CHICAGO, IL, 60690, US

(73) Assignee: NESTEC S.A., Vevey (CH)

(21) Appl. No.: 11/814,414

(22) PCT Filed: Jan. 18, 2006
(86) PCT No.: PCT/EP06/00402

§ 371 Date: Jul. 20, 2007

(30) Foreign Application Priority Data
Jan. 21, 2005 (EP) 05100386.1

(51) Int. Cl. B67D 3/00

(52) U.S. Cl. 222/514

(57) ABSTRACT

A container (1) comprising a container body (2) and a dispensing closure (4), the closure comprising walls (5), at least one dispensing aperture (6), at least one closing element (7) that is movable between a position where said aperture is closed, and a position where the aperture is open, said closure further comprising at least one actionable means (8) that surrounds the closure walls and the closing element. The container is characterized in that the dispensing closure further comprises at least one connection element (10) located between the actionable means and the closing element, said connection element being made of a material that is rigid enough below a predetermined safety temperature, to connect said actionable means and said closing element, thus allowing opening of the dispensing aperture by moving said actionable means, and fluid above said temperature so that said actionable means and said closing element are disconnected, thus preventing opening of the dispensing aperture when moving said actionable means.

The present invention relates to a container, preferably a pressurized container for containing a frozen viscous product, said container having a dispensing closure with a safety system that prevents dispensing of the contained product when the temperature of the container is above a predetermined safety temperature.

More precisely, the safety system ensures that a consumer cannot actuate the dispensing valve system when the product is too fluid.

For the packing and dispensing of products, it is known to use pressurized containers comprising dispensing valves.

A dispensing valve allows a consumer to efficiently dose and dispense the product.

In the following description and for the sake of the clarity of the description, the product contained in the container of the invention is described as soft ice cream. However, it should be understood that this example is not limitative, and that other types of temperature sensitive products can also suitably be packaged in the container of the invention.

It has been found that some products, like for example soft ice cream have to be dispensed from the container into which they are stored, at a certain, predetermined temperature.

In the example of soft—“Italian-like”—ice cream, there are two reasons for this temperature. Firstly, for the soft ice cream to have a nice appearance to the consumer when it is dispensed, it is known that the dispenser has to be at a temperature less than about −17° C. If the dispenser is warmer at the time the consumer uses it, then the ice cream is too fluid cannot be properly eaten, which is clearly disadvantageous to the consumer.

More importantly, for soft ice cream that is stored in a pressurized container, if the container is too warm and therefore if the ice cream is too fluid, there is a risk that ice cream squirts out of the container opening with force, which is clearly disadvantageous to the consumer, as ice cream will be spilled everywhere around.

Therefore, a need exists for a container, especially but not necessarily a pressurized container, that comprises a system to prevent dispensing of the contents if the temperature of the container is above a predetermined temperature, at the time of dispensing.

The present invention addresses the problems set out above with a container for storing and dispensing a product, said container comprising:

(i) a container body having an opening, for containing the product,

(ii) a dispensing closure attached to the container body opening, and comprising closure walls, at least one dispensing aperture, at least one closing element that is movable relative to the closure walls between a first position where said dispensing aperture is closed, and a second position where the dispensing aperture is open and the product is dispensed, said closure further comprising at least one actionable means that surrounds said closure walls and said closing element,

(iii) a spring element disposed between said closing element and said closure walls, so as to naturally force the closing element in a position where it closes said aperture.

According to the present invention, the container is characterized in that said dispensing closure further comprises at least one connection element that is disposed between said actionable means and said closing element, said element being made of a material that is:
rigid enough, when the temperature of the container is below a predetermined safety temperature, to connect said actionable means and said closing element, thus allowing a consumer to open the dispensing aperture by moving said actionable means, and
fluid when the temperature of the container is above said safety temperature, so that said actionable means and said closing element are disconnected, thus preventing a consumer to open the dispensing aperture when moving said actionable means.

In a highly preferred embodiment of the invention, the safety temperature is comprised between −35° C. and +50° C., even more preferably comprised between −25° and −10° C.

Also preferably, said connection element is a key.

In a preferred embodiment of the present invention, the actionable means comprises an outer ring that surrounds said closing element.

In a first embodiment of the invention, the closure walls can define a vertical cylindrical channel which is in fluid contact with the interior of the container body, and which comprises at least one lateral dispensing aperture in its upper part, said closing element having the shape of a ring that seals around the channel, and is movable relative to said channel by translation along an axis which is parallel to the longitudinal axis of the channel when the outer ring and the closing element are connected and the outer ring is translated downwards.

In the latter case, said closing element preferably comprises a first horizontal groove located in the periphery of its outer surface, and said outer ring comprises a second horizontal groove located in the periphery of its inner surface, a spring element being located between the closing ring and the closure walls so as to force said closing ring in a position where it closes the dispensing aperture and the first and second grooves face each other, said key element being disposed in said first and second grooves.

Advantageously, in the latter case, the upper outer surface of said closing element protrudes out of said inner ring when said connection element is fluid and said outer ring is translated downwards by the consumer, said upper outer surface comprising indications to the consumer that the container temperature is above the safety temperature.

In a second embodiment of the invention, the closure walls can define a vertical cylindrical channel which is in fluid contact with the interior of the container body, and comprises at least one lateral dispensing aperture in its upper part, said closing element having the shape of a ring that seals around the said channel, and is movable relative to said channel by rotation around an axis which is parallel to the longitudinal axis of the channel when the outer ring and the closing element are connected and the outer ring is rotated.

In the latter embodiment, said channel preferably comprises a first vertical groove located in the periphery of its outer surface, and said closing ring comprises a second vertical groove located in the periphery of its inner surface, said first and second grooves being disposed such that they face each other when the closing ring closes the dispensing aperture, and said key element being disposed in said first and second grooves.

In a particularly preferred embodiment of the invention, the container comprises a pin attached to the closure walls and located inside the nozzle, and having a length such that it is normally arranged into the nozzle, and protrudes out of said nozzle when the actionable means and the closing means are pulled downwards by the consumer.

This pin acts as a “too cold” indicator, that warns the consumer when the contents is too cold to be dispensed: in this case, the product does not flow out of the container because it is solid, or at least too viscous, and therefore when the consumer pulls onto the actionable means, the pin protrudes out of the nozzle and is visible to the consumer. If the contents is warm enough to flow out of the container, then it is dispensed and flows out of the nozzle, thus hiding the “too cold” indicator that is located inside said nozzle.

Preferably, the container according to the invention contains a product which is a viscous product.

More preferably, said product is a frozen viscous food product.

Advantageously, the container according to the present invention is a pressurized container.

As it will be understood, the present invention achieves some improvements and advantages, over the containers previously known, which do not comprise a safety temperature system. Especially, the safety system is independent from the type of product that is stored into the container: the sole parameter to activate the safety system is the temperature of the container.

The invention will now be described in greater detail, with reference to the attached set of drawings, which represent one embodiment of a container according to the present invention. The following example is given by way of illustration only and in no way should be construed as limiting the scope and subject matter of the invention as described and claimed.

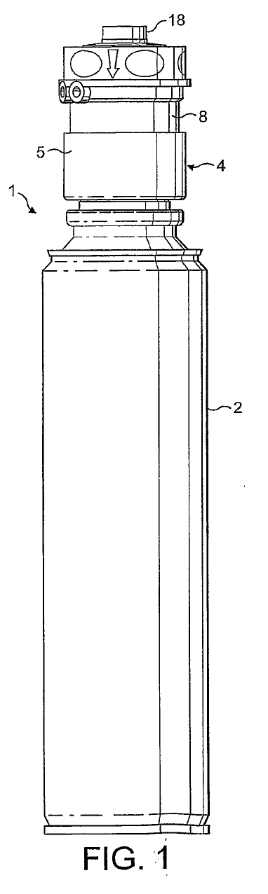

FIG. 1 is a profile view of a container according to the present invention;

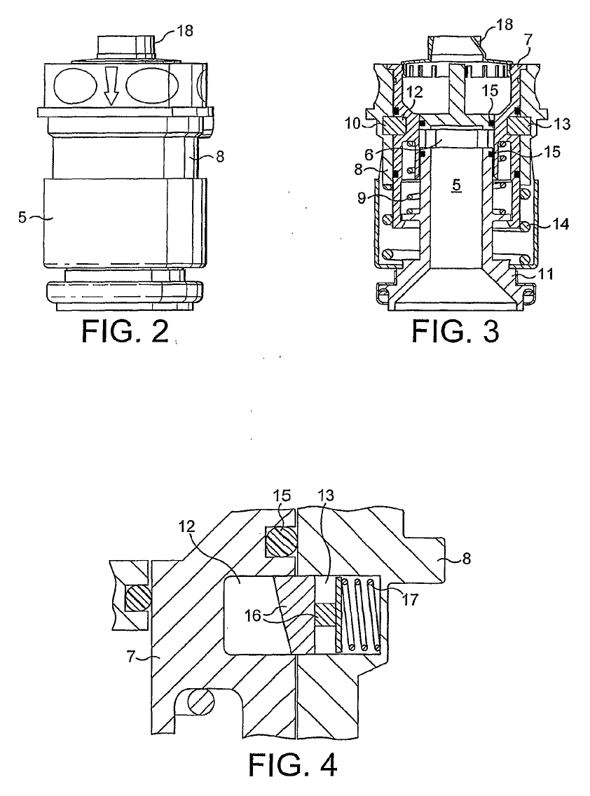

FIG. 2 is a profile view of a closure according to the invention;

FIG. 3 is a profile cut view of a closure according to the invention, in the closed configuration;

FIG. 4 is an enlarged view of an alternative embodiment of the temperature safety system in a closure according to the invention, when the container temperature is below the safety temperature;

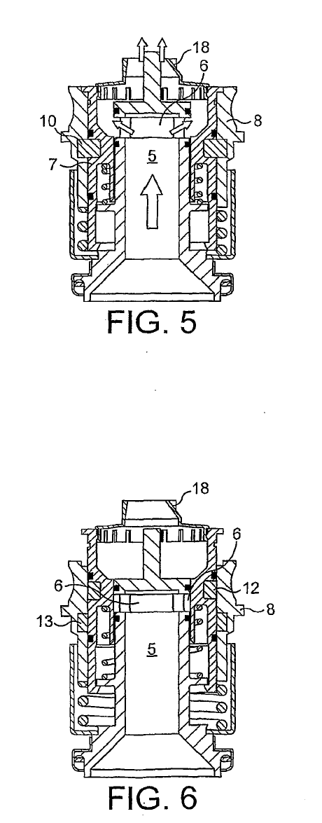

FIG. 5 is a profile cut view of a closure according to the invention, in the open configuration;

FIG. 6 is a profile cut view of a closure according to the invention, in the safety configuration;

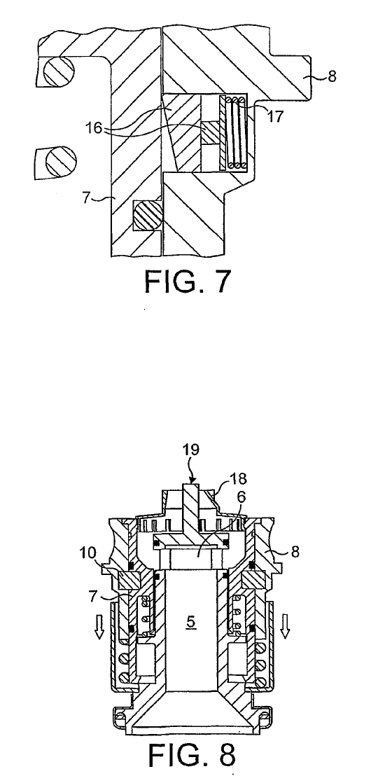

FIG. 7 is a profile cut view of an alternative embodiment of the temperature safety system in a closure according to the invention, when the container temperature is above the safety temperature and the closure is in the safety configuration;

FIG. 8 is a profile cut view of the container in the dispensing configuration, in case the container temperature is too low, and the “too cold” indicator appearing in the nozzle region.

In the following description, and for the sake of clarity, the container of the invention as well as all of its components, are considered in the vertical position, so that the closed side of the container body is in contact with a flat horizontal support, and the side of the container body to which the closure is attached is oriented upwards.

In the example shown in FIG. 1, the longitudinal axis of the container is vertical when said container is considered vertical.

FIG. 1 represents one embodiment of a container according to the present invention.

The container 1 represented in FIG. 1 is a pressurized container for storing and dispensing a frozen viscous product, for example soft ice cream.

The container 1 comprises a container body 2 for containing the product having an opening 3, and a dispensing closure 4 sealingly attached to the container body opening 3 which is represented in an enlarged view in FIG. 2.

The dispensing closure 4 comprises closure walls 5, at least one dispensing aperture 6, at least one closing element 7 that is movable relative to the closure walls between a first position where said dispensing aperture 6 is closed, and a second position where the dispensing aperture is open and the product is dispensed.

The closure 4 further comprises at least one actionable means 8 that surrounds said closure walls 5 and said closing element 7.

A spring element 9 is disposed between said closing element 7 and said closure walls 5, so as to naturally force the closing element in a position where it closes said aperture 6.

According to the present invention, the container is characterized in that said dispensing closure 4 further comprises at least one connection element 10 that is disposed between said actionable means 8 and said closing element 7. Said connection element 10 is a key.

The key 10 is made of a material that is:
rigid enough, below a predetermined safety temperature, to connect said actionable means 8 and said closing element 7, thus allowing a consumer to open the dispensing aperture 6 by moving said actionable means 8, and
fluid, at or above said safety temperature, so that said actionable means 8 and said closing element 7 are disconnected, thus preventing a consumer to open the dispensing aperture 6 when moving said actionable means.

The material that is used for the connecting means 10 can comprise any eutectic material suitable for meeting the melting conditions stated above. It can be a pure liquid, or a mixture. It can be for example water, a propylene glycol based mix, an alcohol based mix, or even the same product as is contained inside the container body.

In the embodiment of the invention that is currently described, and having regard to the fact that the product contained inside the container is soft ice cream, the safety temperature is around −17° C.

The actionable means 8 comprises an outer ring that surrounds and is movable relative to said closing element 7.

In a first embodiment of the invention that is represented in FIGS. 2 to 7, the closure walls 5 define a vertical cylindrical channel which is in fluid contact with the interior of the container body 2.

The channel 5 comprises a lateral dispensing aperture 6 in its upper part, and a shoulder portion 11 in its lower part. The closing element 7 has the shape of a ring that seals around the channel 5, and is movable relative to said channel by translation along an axis which is parallel to the longitudinal axis of the channel.

In this latter case, as represented in FIGS. 3 and 4, the closing element 7 comprises a first horizontal groove 12 located in the periphery of its outer surface, and said outer ring 8 comprises a second horizontal groove 13 located in the periphery of its inner surface.

The first and second grooves 12, 13 are disposed such that they face each other when the outer ring 8 closes the dispensing aperture 6, as represented in FIG. 3, and the key element 10 is disposed in said first and second grooves that both form an annular horizontal cavity.

A spring element 14 is located between the closing ring 7 and the closure walls 5 so as to force said ring in a position where the first and second grooves face each other. More precisely, this spring element 14 presses on the closure walls in the region of the shoulder 11.

In the region of the keyway, the surfaces of the outer ring and the closing ring contact each other in a fluid-tight manner. The tightness is achieved by two horizontal annular joints 15 that are disposed between the closing ring and the outer ring. Both joints 15 are distant from each other so that the first and second grooves 12, 13 are contained in the space in-between the joints 15, as shown in FIGS. 5 and 6.

Similar tightness joints are disposed between the channel and the inner ring.

The way of operating the container and closure of the invention is as follows.

At rest, the closing ring 7 is in the upward position and closes the lateral opening of the dispensing channel 5, as represented in FIG. 3. Simultaneously, the outer ring 8 is also in the upward position as represented in FIG. 3.

The first and second grooves 12, 13 of the closure face each other as represented in FIG. 3.

In the alternative embodiment represented in FIG. 4, the key element 10 located in the first and second grooves of the closure comprises not only a material that is liquid above −17° C., but also a mechanical element 16 that is biased and associated to a spring element 17 that forces the mechanical element across the first and second grooves 12, 13 of the closure to reinforce the connection between the outer ring 8 and the closing ring 7.

When the container temperature is below the predetermined safety temperature (for example less than −17° C. in the present example), and when the consumer wishes to dispense some ice cream, he/she pulls the outer, ring 8 downwards, as is represented in FIG. 5. Pulling the outer ring, leads the closing ring 7 downward as well, since both closing and outer rings are connected to each other by the rigid key 10, and ice cream can flow upwards, out of the channel 5 through the lateral dispensing aperture, as shown by arrows in the FIG. 5. A nozzle 18 can be added to give a particular shape to the dispensed product.

In case the container temperature is too low, the ice cream may be too viscous to flow, and a set of instructions will be therefore given to the consumer onto the container, explaining what is the best dispensing temperature range. In the case the container temperature would be too low, the consumer will have to warm it, for example by letting it out of the freezer at room temperature until the container temperature is higher enough.

In this case, when the temperature of the container is too low, at the time the consumer pulls the outer ring downwards, as shown in the FIG. 8, the ice cream does not flow. At this time, the consumer can see a “too cold” indicator 19 which protrudes out of the nozzle 18, and which is marked with the wording “too cold”. The “too cold” indicator has the shape of a pin attached to the closure walls and located inside the nozzle, and having a length such that it is normally arranged into the nozzle, and protrudes out of said nozzle when the actionable means and the closing means are pulled downwards by the consumer. A set of instructions written onto the container indicates the consumer how too proceed to raise the container's temperature properly in order to reach the dispensing temperature. At correct dispensing temperature, the ice cream normally flows out of the container nozzle, therefore hiding the “too cold” indicator, as shown in FIG. 5.

In the case the container temperature is too high, the key element 10 will become fluid, and will no longer connect the closing ring and the outer ring. In that case, as shown in FIG. 6, pulling downward the outer ring 8, will not lead the closing ring 7 downwards as well, and the channel dispensing aperture 6 will stay closed.

In that configuration, the outer upper surface of the closing ring becomes visible to the consumer, as shown in FIG. 6, and this visible portion can advantageously be printed with a message (not represented in the drawings), informing the consumer that the container temperature is too high for dispensing the contents.

In the alternative embodiment of the key, wherein said key comprises not only liquid but also a mechanical element 16, as represented in FIG. 7, since the key is fluid, forcing down the outer ring will cause the biased portion of the mechanical element to abut the outer surface of the closing ring and be forced horizontally into the groove of the outer ring, as shown in FIG. 7. This will result in the same configuration as that shown in FIG. 6, wherein the outer ring is pulled downwards, but the closing ring stays in the upward position, closing the lateral aperture of the dispensing channel.

In all cases, when the consumer releases the outer ring, said ring is forced upward by the spring element located between said outer ring and the closure walls, as it is illustrated in FIG. 3.

In a second embodiment of the invention (not represented in the drawings), the closure walls can define a vertical cylindrical channel which is in fluid contact with the interior of the container body, and comprises at least one lateral dispensing aperture in its upper part, said closing element having the shape of a ring that surrounds said channel, and is movable relative to said channel by rotation around an axis which is parallel to the longitudinal axis of the channel, a spring, element being located between the closing ring and the closure walls so as to force said ring in a position where the first and second grooves face each other.

In this second embodiment, said closing ring comprises a first vertical groove located in the periphery of its outer surface, and said outer ring comprises a second vertical groove located in the periphery of its inner surface, said first and second grooves being disposed such that they face each other when the closing ring closes the dispensing aperture, and said key element being disposed in said first and second grooves.

The functionality of the container closure in this second embodiment does not change compared to that of the first embodiment described above. In this case, the dispensing of the product is achieved by rotating the outer ring around its longitudinal axis, instead of translating it downwardly as was the case for the first embodiment of the invention.

It should be understood that various changes and modifications to the presently preferred embodiments described herein will be apparent to those skilled in the art. Such changes and modifications can be made without departing from the spirit and scope of the present invention and without diminishing its attendant advantages. It is therefore intended that such changes and modifications be covered by the appended claims.

1. A container for storing and dispensing a product comprising:
a container body having an opening, for containing the product,
dispensing closure attached to the opening, and comprising closure walls, at least one dispensing aperture, at least one closing element that is movable relative to the closure walls between a first position where the dispensing aperture is closed, and a second position where the dispensing aperture is open and the product is dispensed, the closure further comprising at least one actionable means that surrounds the closure walls and the closing element,
a spring element disposed between the closing element and the closure walls, to urge the closing element in a position where it closes aperture,
the dispensing closure comprises at least one connection element that is disposed between the actionable means and the closing element, the element being made of a material that is:
rigid enough, when the temperature of the container is below a predetermined safety temperature, to connect the actionable means and the closing element, thus allowing a consumer to open the dispensing aperture by moving the actionable means, and
fluid when the temperature of the container is above the safety temperature, so that the actionable means and the closing element are disconnected, thus preventing a consumer from opening the dispensing aperture when moving the actionable means.

2. A container according to claim 1, wherein the safety temperature is between −35° C. and +50° C.

3. A container according to claim 1, wherein the connection element is a key.

4. A container according to claim 1, wherein the actionable means comprises an outer ring that surrounds the closing element.

5. A container according to claim 4, wherein the closure walls define a vertical cylindrical channel which is in fluid contact with the interior of the container body, and which comprises at least one lateral dispensing aperture in its upper part, the closing element having the shape of a ring that seals around the channel, and is movable relative to the channel by translation along an axis which is parallel to the longitudinal axis of the channel when the outer ring and the closing element are connected and the outer ring is translated in a downward direction.

6. A container according to claim 5, wherein the closing element comprises a first horizontal groove located in the periphery of its outer surface, and the outer ring comprises a second horizontal groove located in the periphery of its inner surface, a spring element located between the closing ring and the closure walls so as to urge the closing ring in a position where it closes the dispensing aperture and the first and second grooves face each other, the key element being disposed in the first and second grooves.

7. A container according to claim 6, wherein the upper outer surface of the closing element protrudes out of the inner ring when the connection element is fluid and the outer ring is translated in a downward direction by the consumer, the upper outer surface comprising indications to the consumer that the container temperature is above the safety temperature.

8. A container according to claim 4, wherein the closure walls define a vertical cylindrical channel which is in fluid contact with the interior of the container body, and comprises at least one lateral dispensing aperture in its upper part, the closing element having the shape of a ring that sealingly surrounds the channel, and is movable relative to the channel by rotation around an axis which is parallel to the longitudinal axis of the channel, when the outer ring and the closing element are connected and the outer ring is rotated.

9. A container according to claim 8, wherein the closing ring comprises a first vertical groove located in the periphery of its outer surface, and the outer ring comprises a second vertical groove located in the periphery of its inner surface, the first and second grooves being disposed such that they face each other when the closing ring closes the dispensing aperture, and the key element being disposed in said first and second grooves.

10. A container according to claim 5, which comprises a pin attached to the closure walls and located inside the nozzle, and having a length such that it is normally located in the nozzle, and protrudes out of the nozzle when the actionable means and the closing means are pulled downwards by the consumer.

11. A container according to claim 1, wherein the product is a viscous product.

12. A container according to claim 1, wherein the product is a frozen viscous food product.

13. A container according to claim 1, wherein it is a pressurized container.

14. A container for storing and dispensing a product comprising:
a container body having an opening, for containing the product,
a dispensing closure attached to the container, and comprising closure walls, at least one dispensing aperture, at least one closing element that is movable relative to the closure walls between a first position where the dispensing aperture is closed, and a second position where the dispensing aperture is open and the product is dispensed, the closure further comprising at least one member that surrounds said closure walls and said closing element,
a spring element disposed between the closing element and the closure walls, so as to urge the closing element in a position where it closes the aperture, and
the dispensing closure comprises at least one connection element that is located between the member and the closing element, the element being made of a material that when the temperature of the container is below a predetermined temperature, it causes the member and the closing element, to allow a consumer to open the dispensing aperture by moving the member, and when the temperature of the container is above the temperature, the member and the closing element are disconnected, preventing a consumer from opening the dispensing aperture when moving the member.

15. A container according to claim 1, wherein the safety temperature is between −25° C. and −10° C.
